(19) United States
(12) Patent Application Publication
(10) Pub. No.: US 2002/0144763 A1
(43) Pub. Date: Oct. 10, 2002

(54) Tire for running on iced and/or snowed road, and tire stud for the same

(76) Inventor: Yoshio Komatsu, Tokyo (JP)

Correspondence Address: SEAN M. MCGINN, MCGINN & GIBB, PLLC, 8321 OLD COURTHOUSE ROAD, SUITE 200, VIENNA, VA, 22182-3817, US

(21) Appl. No.: 09/771,652

(22) Filed: Jan. 30, 2001

(51) Int. Cl. B60C 11/12; B60C 11/16; B60C 11/14

(52) U.S. Cl. 152/211

(57) ABSTRACT

In a stud embedded in a tire to provide the braking force, a set of a plurality of long stud elements are arranged adjacent to one another and bundled into a predetermined shape with one end faces thereof faced to a road. Each of the stud elements is formed by a synthetic fiber or a synthetic resin wire. The stud further has a filler filled in a space between adjacent ones of the stud elements to fasten the stud elements to one another. The stud is deflected during running to distribute the stress so that the desired braking force is assured and the durability is improved.

### BACKGROUND OF THE INVENTION

This invention relates to a tire stud used in a tire for running on a road and to a studded tire having a tire stud.

As a tire for running on a road covered with ice or snow deposited thereon, a studded tire is known. In such a studded tire, a number of studs or projections of hard metal are embedded with being partially protruded. Thus, the studded tire is given braking force sufficient to grip the road covered with ice or snow. However, such studded tire is disadvantageous in that the pavement of the road is chipped off by the studs during running and this causes dust pollution. In addition, the road itself is chipped off by the studs to be damaged and worn so that the road suffers from rapid deterioration. Therefore, in most regions, the use of the studded tire is restricted or regulated by law and, in fact, prohibited.

In this viewpoint, it is desired to develop a tire having braking force without using the studs made of hard metal, i.e., a studded tire provided with studs made of a material, such as synthetic resin, having a hardness such that the pavement of the road is not damaged and worn.

However, if the tire is provided with pin-type resin studs having such a hardness that the road is not damaged, such studs tends to be depressed soon below a tread of the tire after running over the distance of about 1,000 km. In addition, tips of the studs will be worn and rounded to lose the braking force.

Under the circumstances, the studded tire is replaced by a studless tire which is predominantly used at present. The studless tire has been improved to increase adhesion by using softer rubber or the like.

However, the studless tire is notably inferior in braking force as compared with the studded tire having the studs made of hard metal or resin. Therefore, a driver feels using the studless tire has an uneasiness and dissatisfaction during driving.

### SUMMARY OF THE INVENTION

It is therefore an object of this invention to provide a tire stud and a studded tire which simultaneously assure the braking force and the durability without causing dust pollution and damaging a road.

According to this invention, there is provided a tire stud for use in a tire portion having a tread to be contacted with a road, the tire stud comprising a set of a plurality of long stud elements arranged adjacent to one another and bundled in a predetermined shape.

According to this invention, there is also provided a studded tire comprising a tire portion which has a tread to be contacted with a road, and a plurality of tire studs embedded in the tire portion with being partially protruded from the tread, the tire stud comprising a set of a plurality of long stud elements arranged adjacent to one another and bundled in a predetermined shape so that one ends of the stud elements are faced to the road.

### BRIEF DESCRIPTION OF THE DRAWING

FIG. 1 is a perspective view of a tire stud according to one embodiment of this invention;

FIG. 2 is a sectional view taken along a line A-A′ in FIG. 1;

FIG. 3 is an enlarged plan view which corresponds to a part depicted at S in FIG. 1 and which shows a modification of the tire stud illustrated in FIG. 1;

FIG. 4 is a plan view showing a characteristic part of a tire having the tire stud illustrated in FIG. 1;

FIG. 5 is a sectional view taken along a line B-B′ in FIG. 4;

FIG. 6 is a sectional view taken along a line C-C′ in FIG. 4;

FIG. 7 is a graph showing the change in height of the stud at a point A in FIG. 6;

FIG. 8 is a graph showing the change in height of the stud at a point B in FIG. 6;

FIG. 9 is a graph showing the change in height of the stud at a point C in FIG. 6;

FIG. 10 is a graph showing the change in height of the stud in case where a cushion member in FIG. 6 is omitted;

FIG. 11 is a graph showing the change in height of a tread in FIG. 5;

FIG. 12 is a plan view showing a test piece of the tire illustrated in FIG. 4 and a mount table on which the test piece is placed;

FIG. 13 is a front view of FIG. 12;

FIG. 14 is a view for describing a traction test for the test piece illustrated in FIG. 12;

FIG. 15 is a graph showing test data obtained in a first test cycle for a comparative test piece having no stud;

FIG. 16 is a graph showing test data obtained in the first test cycle for the test piece illustrated in FIG. 12;

FIG. 17 is a graph showing test data obtained in a second test cycle for the comparative test piece;

FIG. 18 is a graph showing test data obtained in the second test cycle for the test piece illustrated in FIG. 12;

FIG. 19 is a graph showing test data obtained in a third test cycle for the comparative test piece;

FIG. 20 is a graph showing test data obtained in the third test cycle for the test piece illustrated in FIG. 12;

FIG. 21 is a graph showing test data obtained in a fourth test cycle for the comparative test piece;

FIG. 22 is a graph showing test data obtained in the fourth test cycle for the test piece illustrated in FIG. 12;

FIG. 23 is a graph showing test data obtained in a fifth test cycle for the comparative test piece;

FIG. 24 is a graph showing test data obtained in the fifth test cycle for the test piece illustrated in FIG. 12;

FIG. 25 is a view for describing a behavior of the stud; and

FIG. 26 is a view for describing calculation of an intermediate value.

### DESCRIPTION OF THE PREFERRED EMBODIMENT

Now, description will be made of a tire stud and a studded tire according to one embodiment of this invention with reference to the drawing.

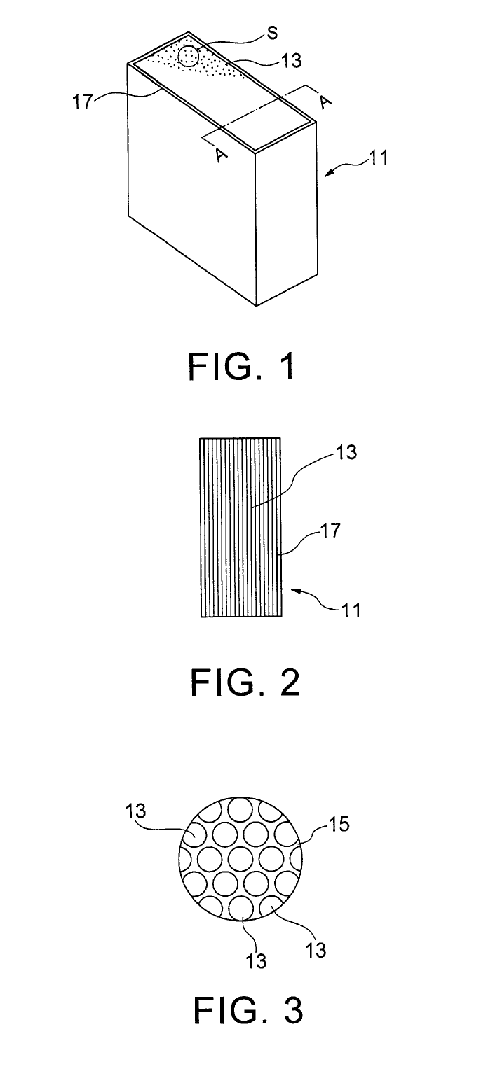

Referring to FIGS. 1 and 2, the stud depicted by 11 comprises a plurality of long stud elements 11. Each of the stud elements 13 has opposite end faces perpendicular to a longitudinal direction thereof. One of the opposite end faces is a portion to confront a road and to be brought into contact with the road. The stud elements 13 are arranged adjacent to one another and bundled in a predetermined shape to form an assembly as the stud 11. The stud 11 illustrated in FIG. 1 comprises a bundle of the stud elements 13 formed into a columnar shape having a rectangular section.

Each of the stud elements 13 is made of a synthetic fiber such as a nylon fiber or a synthetic resin wire such as a nylon wire. For example, the stud 11 is composed of a bundle of a plurality of the stud elements 3 each of which comprises a nylon wire having a diameter of 0.30 mm. The stud 11 is held at a predetermined position of the tire.

Thus, in order to assure both the braking force and the durability, the stud 11 comprises a plurality of the stud elements 13 which are made of the synthetic fiber or the synthetic resin wire, alone or in combination. With this structure, the stud 11 is subjected to a reduced load because the stress is distributed by the flexibility of the stud elements 13. As a consequence, the stud 11 is improved in durability.

Referring to FIG. 3 which corresponds to an encircled portion depicted by S in FIG. 1, the stud 11 may further comprise a filler 15 of synthetic resin filled in a space between adjacent ones of the stud elements 13 to fasten the stud elements 13 to one another.

The filler 15 has a hardness such that the pavement of the road is not damaged thereby. By the use of the filler 15, the stud 11 is increased in rigidity to further improve the braking force and the durability.

The filler 15 also serves as a shaping or forming member so that the stud 11 can be formed into any desired shape. It is therefore possible to select an optimum shape to improve the braking force and the durability. It is noted here that the filler 15 is softer than the stud elements 13. The stud 11 with the filler 15 has waterproof and is therefore able to avoid freezing. It is thus possible to prevent the braking force from being degraded due to the freezing.

Turning back to FIGS. 1 and 2, the stud elements 13 may be bundled by the use of a covering member 17, for example, made of a vinyl material. Specifically, a bundle of the stud elements 13 as a whole is covered by the covering member 17 with at least one end faces thereof left uncovered or exposed. In this manner, the stud elements 13 are stably held.

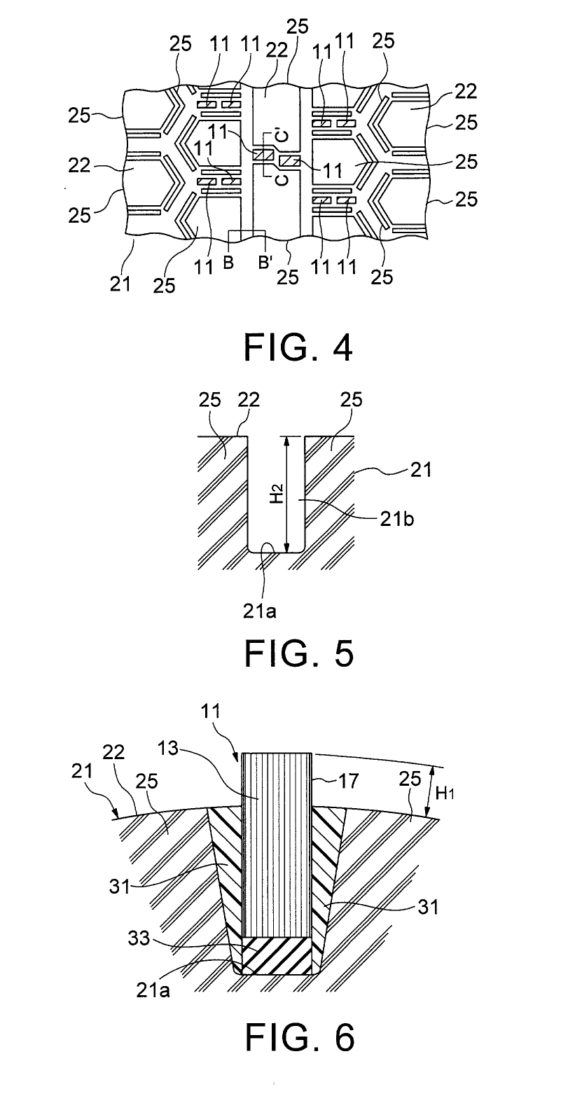

Next referring to FIGS. 4 through 6, description will be made of the studded tire with a number of the above-mentioned studs 11 planted and held therein. The studded tire of this invention comprises a combination of a tire portion 21 and a number of the tire studs 11.

As illustrated in FIGS. 4 through 6, the tire portion 21 has a tread 22 to be brought into contact with the road and a tire base plane 21a below the tread 22. A plurality of the studs 11 are located on the tire base plane 21a to partially protrude above the tread 22. The tire portion 21 has a tread portion comprising a plurality of tread blocks 25 of different shapes integrally formed on the tire base plane 21a to form a predetermined continuous pattern as a tread pattern. As the tread pattern of the tire portion 21, various patterns are well known. Therefore, description of the tread pattern in this embodiment will no longer be made.

In this embodiment, the studs 11 are held by utilizing a plurality of gaps left between adjacent ones of the tread blocks 25. Specifically, the tire portion 21 has a plurality of stud holding portions 21b each of which has a U-shaped section and is formed between adjacent ones of the tread blocks 25. As also illustrated in FIG. 6, the stud 11 is held in the stud holding portion 21b with a reinforcing resin material 31 filled between the inner surface of the stud holding portion 21b and the outer surface of the stud 11. The reinforcing resin material 31 serves to protect the stud 11 against mechanical force exerted in various directions.

Furthermore, a cushion member 33, such as rubber, having elastic restoring force is arranged between the tire base plane 21a in the stud holding portion 21b and the other end of the stud 11. The cushion member 33 is effective in case where the stud 11 is insufficient in durability. In other words, the cushion member 33 is unnecessary if the stud 11 is sufficient in durability. The material and the dimension of the cushion member 33 may be appropriately selected in dependence upon the specification of a car as well as the specification of the tire portion 21.

Description will hereinafter be made of test results for the studded tire. As the tire portion 21, use was made of a studless tire GRASPIC HS-3 205/65-R15 94Q manufactured and sold by Dunlop. The air pressure within the tire was 2.2 kg/cm². The tread portion had a tread area of 129.9 cm² and was subjected to a load of 413 kg. The tread blocks were given a tread pressure of 3.2 kg/cm^{2.}

The stud 11 had a section of 4 mm×10 mm and a length selected within a range between 6 and 10 mm. The stud 11 protruded by about 0.5 mm (the height H1 shown in FIG. 6) from an upper surface of each tread block 25 which is flush with the tread 22. The stud 11 was formed by nylon wires, 280 in number, as the stud elements 13 with the filler 15 filled in the space between adjacent ones of the wires. Each nylon wire had a diameter of 0.3 mm. Around the outer periphery of the stud 11, a vinyl sheet having a thickness of 0.15 mm was wound as a covering member to reinforce the stud 11. As the filler 15, use was made of Cemedine #8060 Silicone Sealant (tradename).

The material, the sectional dimension, and the shape of the stud elements 13 are not restricted to those used in this embodiment and depend upon the condition of the road.

As the reinforcing resin material 31 illustrated in FIG. 6, use was made of Cemedine #8060 Silicone Sealant (tradename). The cushion member 33 was adhered to each of the tire base plane 21a and the stud 11 by an adhesive (not shown). As the adhesive, use was made of Bond Aron Alpha (tradename).

The cushion member 33 illustrated in FIG. 6 had a height of 2 mm. The space between adjacent ones of the tread blocks 25 was equal to 5 mm on the tire base plane 21a and to 8 mm at upper edges thereof.

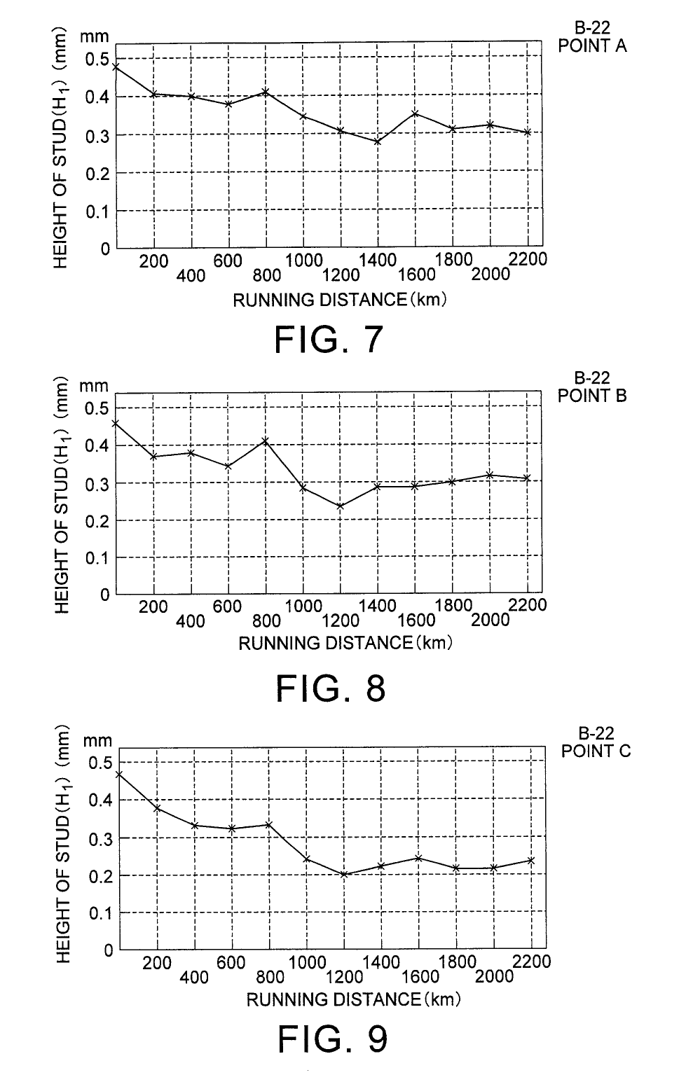

By the use of the studded tire comprising the tire portion 21 with the studs 11 fitted therein as mentioned above, a running test was performed. In the running test, measurement was made of the height H1 (FIG. 6) of the protruding part of the stud 11 protruding above the tread 22 and the height H2 (FIG. 5) of the tread block 25 per every 200 km of the running distance. The result of measurement was shown in FIGS. 7 through 11 as amounts of wear.

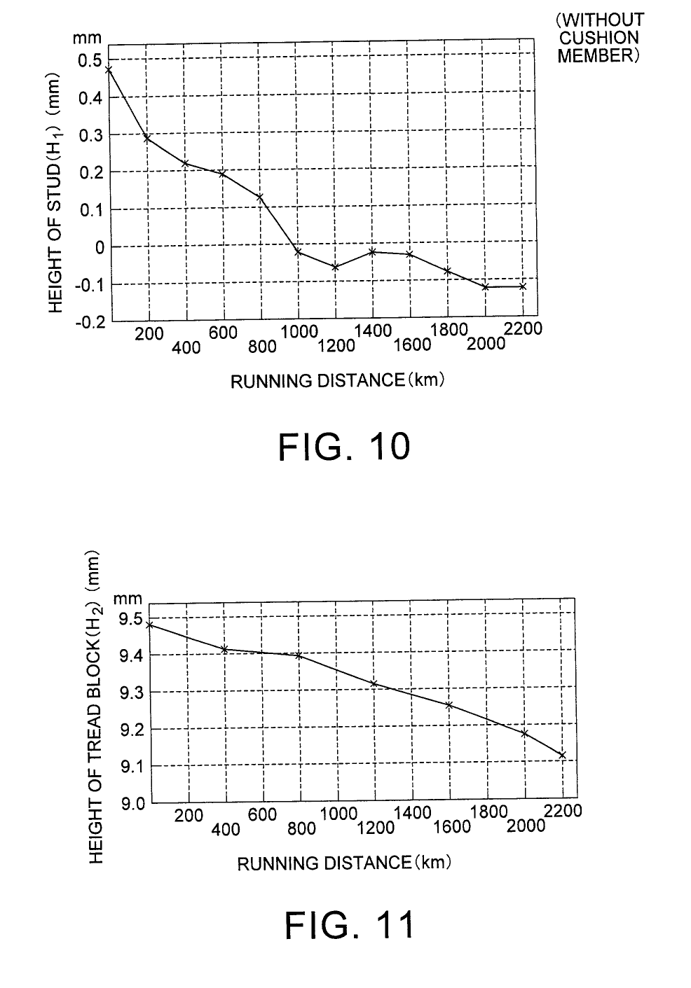

FIGS. 7 through 9 show the measurement result for the height H1 of the stud 11 illustrated in FIG. 6. FIG. 10 shows the measurement result for the height H1 of the stud 11 in case where the cushion member 33 in FIG. 6 is omitted. FIG. 11 shows the measurement result for the height H2 of the tread block 25 in FIG. 5.

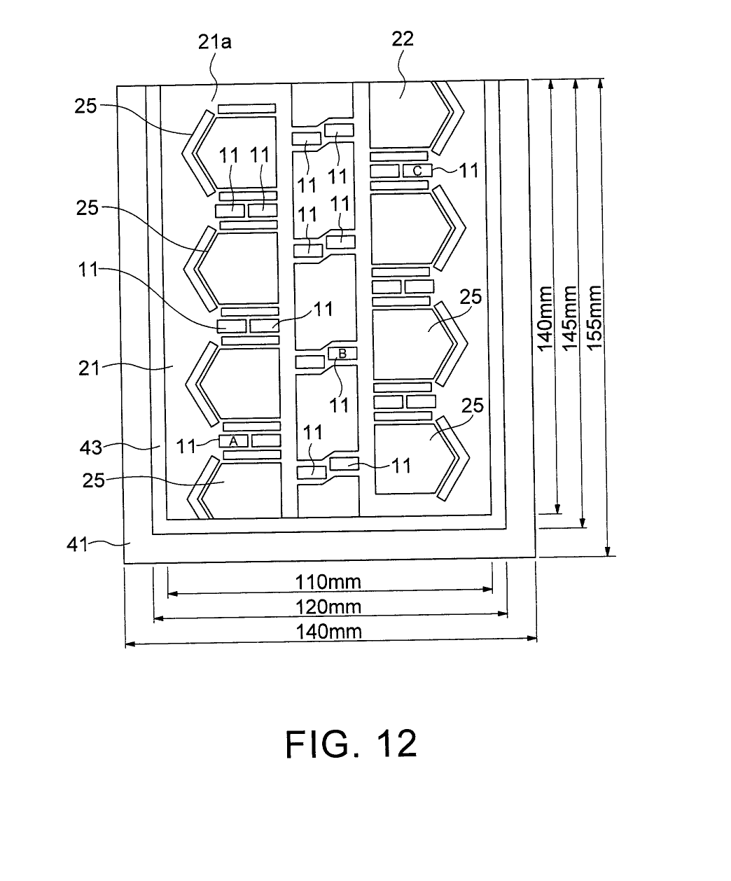

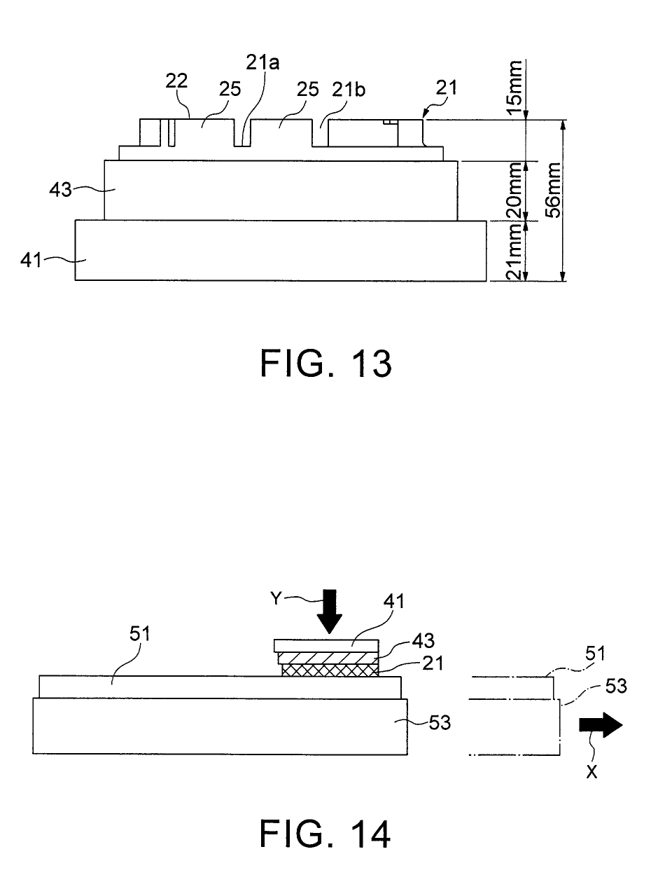

Referring to FIGS. 12 and 13, a part of the studded tire of this invention was used as a test piece which was mounted on a mount table 41.

Between the test piece and the mount table 41 with the test piece mounted thereon, a sponge 43 is interposed. The sponge 43 serves as an air cushion in the studded tire.

The measurement result shown in each of FIGS. 7 through 9 was obtained from the test piece including the cushion member 33 in FIG. 6 and the studs 11, twenty in number, arranged between the adjacent ones of the tread blocks 25 in FIGS. 12 and 13.

For easy understanding, longitudinal and transversal dimensions were written in FIGS. 12 and 13 for each of the test piece, the mount table 41, and the sponge 43.

In FIG. 12, points A, B, and C represent measuring points for the height H1 of the stud 11. Specifically, the points A, B, and C correspond to the data shown in FIGS. 7, 8, and 9, respectively.

Referring to FIG. 14, the test pieces were prepared and subjected to a traction test. In the traction test, each test piece in FIGS. 12 and 13 was placed on an ice block 51 received in an ice box 53, as illustrated in FIG. 14. A load of 200 kgf was imposed on each test piece, as depicted by an arrow Y in the figure. In this state, the ice box 53 is pulled by a motor having a power of 1.5 kw as depicted by an arrow X in the figure. Then, the traction force (T) was measured and recorded as a traction value.

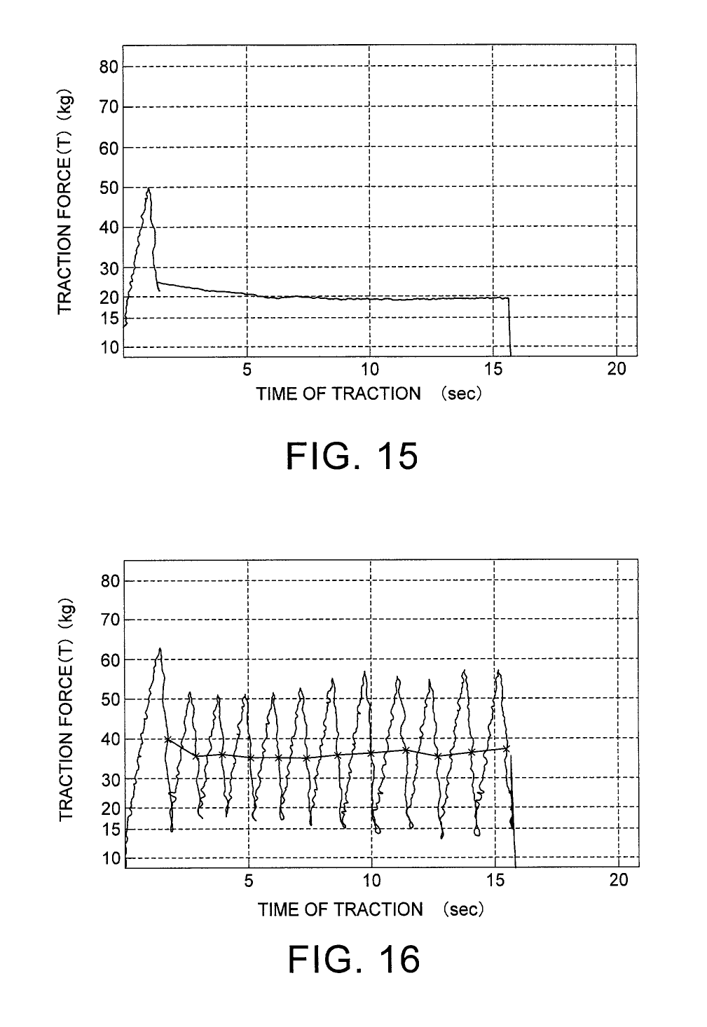

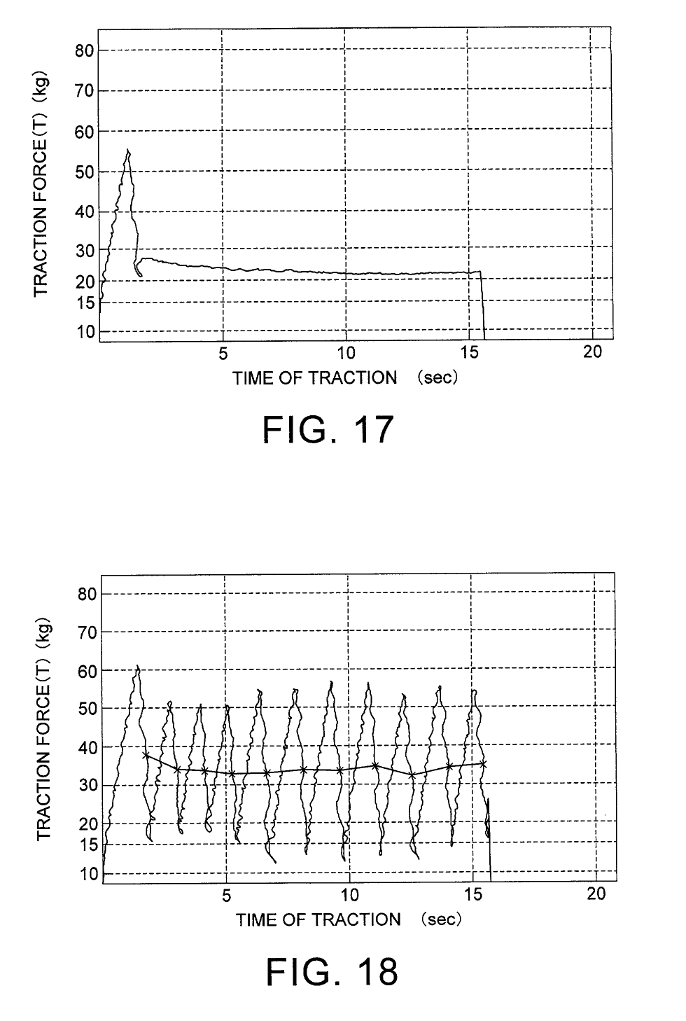

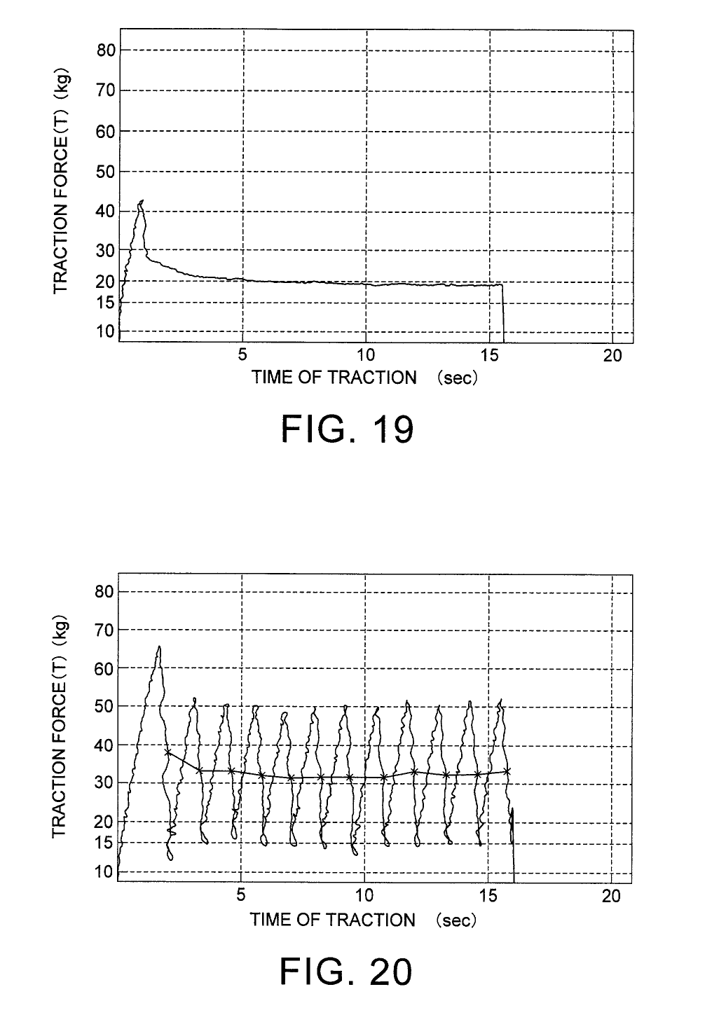

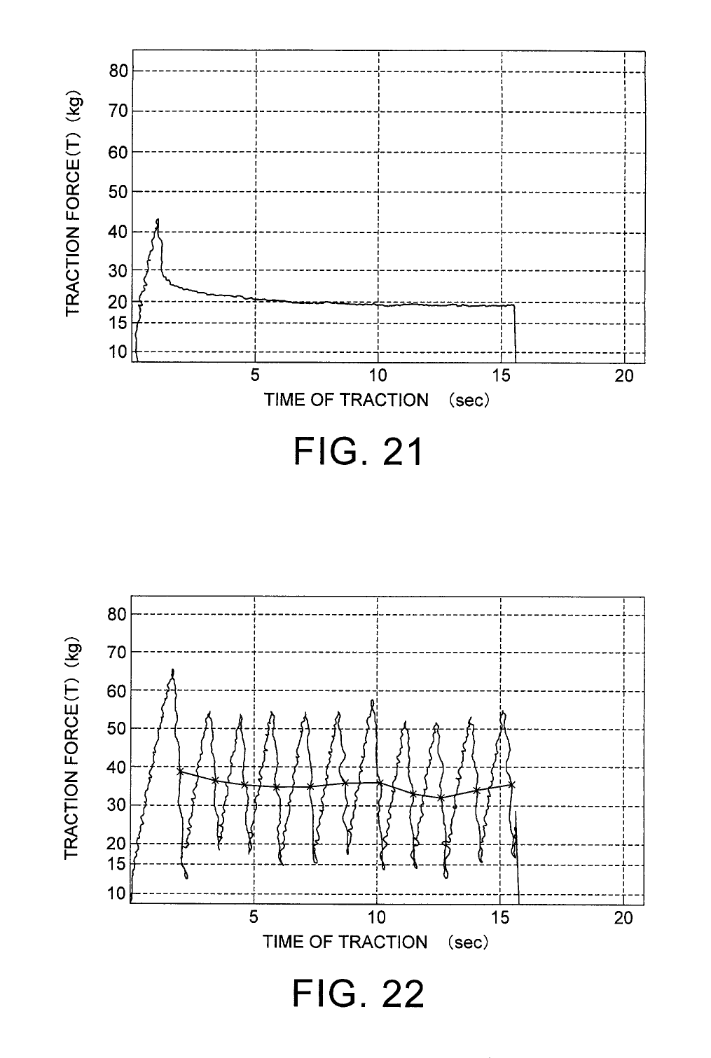

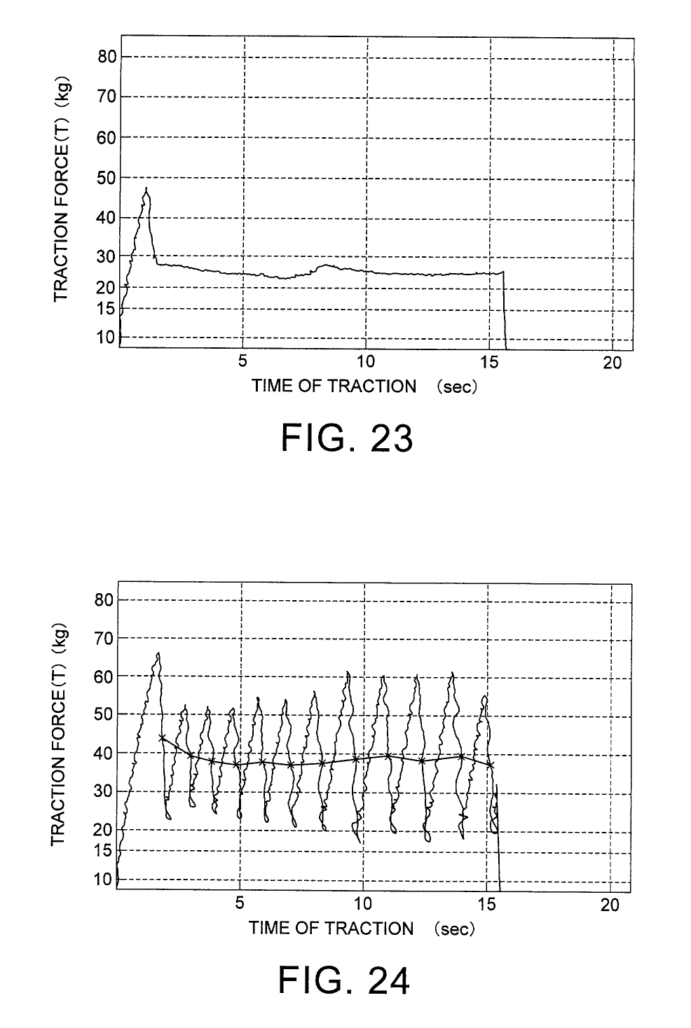

The recorded results are shown in FIGS. 15 through 24. FIGS. 15 and 16, FIGS. 17 and 18, FIGS. 19 and 20, FIGS. 21 and 22, and FIGS. 23 and 24 show the results obtained in first, second, third, fourth, and fifth test cycles, respectively.

In FIGS. 15, 17, 19, 21, and 23, the results were obtained for a comparative test piece (type A-4) which is identical in shape and dimension with the test piece in FIGS. 12 and 13 but does not have the studs 11. On the other hand, the results shown in FIGS. 16, 18, 20, 22, and 24 were obtained for the test piece (type B-22) illustrated in FIGS. 12 and 13.

The traction test was carried out over a stroke of 270 mm during 15.5 seconds at a speed of 1,045 mm/min. It was confirmed that such conditions of the traction test were not changed even when no load was imposed on each test piece. This means that the traction force was accurately measured about each test piece. In other words, comparison between the traction force for the A-4 type illustrated in FIGS. 15, 17, 19, 21, and 23 and the traction force for the B-22 type illustrated in FIGS. 16, 18, 20, 22, and 24 was carried out with a considerably high accuracy.

The moving range of the ice box 53 illustrated in FIG. 14 was covered with a freezing case and controlled in temperature. In this manner, the test conditions were kept as same as possible to achieve the uniformity of the test results. Within the freezing case, it is possible to lower the temperature down to about −15° C. In the traction test, however, the temperature was set within a plus (+) range slightly above zero, i.e., the range between 0.9 and 2.3° C. In this temperature range, no water film is generally present on an ice surface. However, if the ice block 51 is moved, the water film tends to be produced between the ice surface and the test piece so that the test piece is very easy to slide. In such a bad condition, the difference in traction force between the A-4 type and the B-22 type would be more remarkable. This is the reason why the above-mentioned temperature range was selected.

Referring to FIGS. 7 through 10, the test results will be described. The height H1 of the stud 11 and the height H2 of the tread block 25 of the tire portion 21 were measured at every 200 km of the running distance. The values taken at every 200 km points were plotted.

Consideration will be made of the variation in height H1 of the stud 11 in each of FIGS. 7 through 9. As seen from the figures, the height H1 is reduced until the running distances of 1,400 km, 1,200 km, and 1,200 km are reached with respect to the points A, B, and C in FIGS. 7, 8, and 9, respectively. Beyond each of the above-mentioned distances, the height H1 was substantially kept within a certain narrow range for each of the points A, B, and C. This means that, beyond the above-mentioned running distances, the wear amount of the stud 11 and the wear amount of the tread block 25 are balanced. It is presumed that this balance will be maintained over the running distance of 2,200 km. Thus, the stud 11 has a sufficient durability (wear resistance).

Referring to FIG. 10, the height H1 of the stud 11 was depressed below the surface of the tread block 25 at the point of 1,000 km of the running distance. At the point of 2,200 km of the running distance, the height H1 was equal to −0.1 mm. However, the depression may possibly be continued thereafter. Comparing the graph in FIG. 10 with the graphs in FIGS. 7 through 9, the effect of the cushion member 33 is proved.

Referring to FIG. 11, the wear amount of the tread block 25 was 0.37 mm at the point of 2,200 km of the running distance. The running speed was 60-70 km/h.

Referring to FIGS. 15 through 24, description will be made of braking performance. In these figures, the test piece has a greater resistance as the traction force T has a greater value. This corresponds to greater braking force.

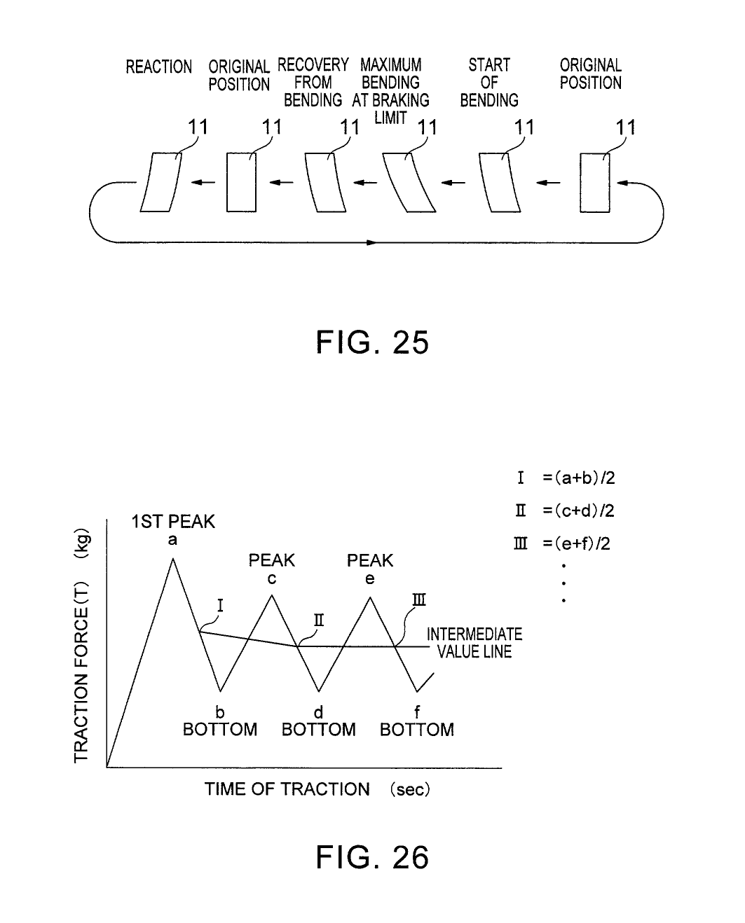

In FIGS. 16,18, 20, 22, and 24, the variations in the graphs are great. This is because the stud 11 performs the behavior illustrated in FIG. 25. Specifically, the stud 11 repeats a cycle from an original position, the start of bending, the maximum bending at a braking limit, the recovery from bending, the original position, and the reaction.

When the ice block 51 starts moving, the stud 11 is flexibly bent and increased in braking force so that the traction force T is increased. When an amount of bending becomes maximum, the braking force is reached to an upper limit. Thereafter, the braking force is rapidly and instantaneously reduced at the start of recovery from the bent state of the studs 11 and, as a result, the traction force T is quickly decreased. While the traction force T is decreased, the stud 11 is quickly and flexibly recovered from the bent state and, as a result, the stud 11 recuperates the braking force.

As a result of the repetition of the behavior mentioned above, the traction force T has peaks and bottoms in FIGS. 16, 18, 20, 22, and 24. However, these graphs can not be compared with those of FIGS. 15, 17, 19, 21, and 23. Therefore, an intermediate value between each pair of the peak and the bottom was calculated as the traction force T for the B-22 type. The calculation of the intermediate value will be described with reference to FIG. 26.

In FIG. 26, a first peak a, a peak c, a peak e and a bottom b, a bottom d, and a bottom f are given. The intermediate value line is obtained by connecting the intermediate values I, II, and III given by::

I=(a+b)/2

II=(c+d)/2

III=(e+f)/2

Through the previous tests, it has been confirmed that these intermediate values were substantially coincident with the values without the peak-to-bottom variations. Therefore, these intermediate values can be used for comparison and analysis of the traction force T without any problem. The traction force T for comparison was obtained at the time instant of 10 seconds after the start of pulling, i.e., when the traction force becomes stable. The result of comparison of the traction force T is shown in Table 1. The traction force T in each of FIGS. 16, 18, 20, 22, and 24 is equal to 1.68 times that in each of FIGS. 15, 17, 19, 21, and 23. Thus, the braking force is remarkably improved in the former.

TABLE 1

| | | | | | | | Aver- |
|---|---|---|---|---|---|---|---|
| Item | Test Cycle | 1 | 2 | 3 | 4 | 5 | age |
| A-4 | T (kg) | 19.0 | 21.5 | 19.5 | 19.5 | 25.0 | 20.9 |
| A-4 | μ | 0.095 | 0.108 | 0.098 | 0.098 | 0.125 | 0.105 |
| B-22 | T (kg) | 34.0 | 34.0 | 32.0 | 36.0 | 39.5 | 35.1 |
| B-22 | μ | 0.170 | 0.170 | 0.160 | 0.180 | 0.198 | 0.176 |
| Ratio | (B-22/ | 1.79 | 1.58 | 1.64 | 1.85 | 1.58 | 1.68 |
| of T | A-4) | | | | | | |

μ(coefficient of friction) = T (kg)/200 (kg) (rounded off to three decimals)

Table 1 shows the comparison of the traction force T at the 10-second pulling point. In Table 1, the traction force T in FIGS. 15, 17, 19, 21, 23 is given in the row labeled A-4 while the traction force T in FIGS. 16, 18, 20, 22, and 24 is given in the row labeled B-22. In addition, the average of the test cycles 1 through 5 is also shown. The symbol g represents the coefficient of friction and is given by μ=T(kg)/200 (kg).

At present, it is said that 10% improvement of the braking performance of the studless tire is extremely difficult. In contrast, high braking performance of the stud of this invention is proved from the above-mentioned test results. In addition, the durability is sufficient and the stud element can not damage the road, as described above. Therefore, the utility in practical use is also proved.

In the above-mentioned test, the studless tire is used as the tire portion 21. However, the stud of this invention is also applicable to a normal tire without a studless structure. Although this invention assumes a snowy or icy road, the stud of this invention can be also used for a normal or dry road in a technical aspect without changing the illustrated tire. Furthermore, the stud of this invention is particularly effective in safe driving in a rainy day.

As described above in conjunction with the embodiment, the tire stud and the studded tire of this invention simultaneously assure the braking force and the durability. To this end, the stud elements comprising synthetic fibers or synthetic resin wires are bundled to form the stud. The stud elements have flexibility so that the stress is distributed to reduce the load. As a consequence, the durability of the stud is improved.

The stud is not depressed below the tread of the tire. As compared with the studless tire, the braking force is improved.

In the stud of this invention, the stud elements of synthetic fibers or synthetic resin wires are used so as not to damage the road. Even if the end face of each of the synthetic fibers or the synthetic resin wires is rounded in the manner similar to the conventional rod-like stud, the stud as a whole keeps an indented or unsmoothed condition. As a consequence, the braking ability is prevented from being degraded.

Since the stud is bent during running, the durability (wear resistance) is also improved due to the stress distribution effect.

If the rigidity of the stud elements is insufficient, the synthetic fibers or the synthetic resin wires are embedded in the filler of soft synthetic resin to be fastened to one another. With this structure, the rigidity of the stud is increased to improve the braking force. Alternatively, the synthetic fibers or the synthetic resin wires may be directly planted in the rubber of the tire portion. In this case also, the sufficient braking effect is achieved.

The filler also serves as the forming member so that the stud can be formed into any desired shape. It is therefore possible to select an optimum shape to improve the braking force and/or the durability. The filler is softer than the synthetic fiber and the synthetic resin wire. In addition, waterproof for preventing the freezing of the stud can be obtained.

If the durability is still insufficient, an appropriate cushion member is interposed between the tread and the stud.

What is claimed is:

1. A tire stud for use in a tire portion having a tread to be contacted with a road, said tire stud comprising a set of a plurality of long stud elements arranged adjacent to one another and bundled in a predetermined shape.

2. A tire stud as claimed in claim 1, wherein each of said stud elements is formed by at least one of a synthetic fiber and a synthetic resin wire.

3. A tire stud as claimed in claim 1, further comprising a filler filled in a space left between adjacent ones of said stud elements to fasten said stud elements to one another.

4. A tire stud as claimed in claim 3, wherein said filler is softer than said stud elements and has waterproof.

5. A tire stud as claimed in claim 1, further comprising a covering member covering an outer periphery of said stud elements with at least one end faces thereof left uncovered or exposed.

6. A studded tire comprising:
a tire portion which has a tread to be contacted with a road; and
a plurality of tire studs embedded in said tire portion with being partially protruded from said tread;
said tire stud comprising a set of a plurality of long stud elements arranged adjacent to one another and bundled in a predetermined shape so that one ends of said stud elements are faced to said road.

7. A studded tire as claimed in claim 6, wherein each of said stud elements is formed by at least one of a synthetic fiber and a synthetic resin wire.

8. A studded tire as claimed in claim 6, wherein said stud further comprises a filler filled in a space left between adjacent ones of said stud elements to fasten said stud elements to one another.

9. A studded tire as claimed in claim 8, wherein said filler is softer than said stud elements and has a waterproof.

10. A studded tire as claimed in claim 6, wherein said stud further comprises a covering member covering an outer periphery of said stud elements with at least one end faces thereof left uncovered or exposed.

11. A studded tire as claimed in claim 6, wherein said tire has a stud holding portion having a U-shaped section and holding said stud, and a cushion member interposed between a bottom surface of said stud holding portion and the other end of said stud.

12. A studded tire as claimed in claim 6, wherein said tire has a stud holding portion holding said stud, and a reinforcing resin material filled between an inner surface of said stud holding portion and an outer surface of said stud.

13. A studded tire as claimed in claim 6, wherein said stud is located on a tire base plane of said tire through a cushion member having elastic restoring force.
